(19) United States
(12) Patent Application Publication
(10) Pub. No.: US 2014/0356698 A1
(43) Pub. Date: Dec. 4, 2014

(54) BATTERY CELL

(71) Applicant: SK INNOVATION CO., LTD., Jongno-gu, Seoul (KR)

(72) Inventor: Ming Zhe Kong, Daejeon (KR)

(73) Assignee: SK INNOVATION CO., LTD., Jongno-gu, Seoul (KR)

(21) Appl. No.: 14/368,587

(22) PCT Filed: Jan. 9, 2013
(86) PCT No.: PCT/KR2013/000149

§ 371 Date: Jun. 25, 2014

(30) Foreign Application Priority Data
Feb. 7, 2012 (KR) 10-2012-0012228

(51) Int. Cl. H01M 2/30

(52) U.S. Cl. CPC H01M 2/30
USPC 429/179

(57) ABSTRACT

A battery cell comprises: a cell unit configured to include a cathode plate, an anode plate, and a separation membrane; a cathode tab configured to extend from the cathode plate; an anode tab configured to extend from the anode plate; and a case configured to have the cathode tab and the anode tab protruding to an outside and have the cell unit disposed therein to be sealed, wherein one or both of the cathode tab and the anode tab are formed in at least two.

### TECHNICAL FIELD

The present invention relates to a battery cell, and more particularly, to a battery cell capable of preventing durability from reducing due to deterioration and increasing charging and discharging efficiency.

### BACKGROUND ART

Generally, unlike a primary battery, a secondary battery may be charged and discharged to be applied to various fields such as a digital camera, a mobile phone, a notebook, and a hybrid car and thus has been actively researched. An example of the secondary battery may include a nickel-cadmium battery, a nickel-metal hydride battery, a nickel-hydrogen battery, and a lithium secondary battery.

Among these secondary batteries, many studies on the lithium secondary battery having a high energy density and a discharge voltage have been conducted and thus the lithium secondary battery has been commercialized and widely used.

The lithium secondary battery may be manufactured in various types and an example of a representative type may include a cylinder type and a prismatic type which are mainly used in the lithium secondary battery. A recently spotlighted lithium polymer battery is manufactured in a pouched type having flexibility and thus the shape thereof is relatively free.

The secondary battery is formed so that an anode tab and a cathode tab of an anode plate and a cathode plate protrude to the outside and performs charging and discharging through the anode tab and the cathode tab. However, the charging and discharging are repeatedly performed and thus temperature inside a battery cell rises, such that the battery cell may deteriorate and lifespan of the battery cell may be shortened or gas occurs inside the pouch and thus the battery cell has a risk of explosion and fire due to a swelling phenomenon that the battery cell swells, and the like.

Meanwhile, when a plurality of anode plates and cathode plates are present inside a case, a secondary battery internal cell is manufactured in a stack type. Among them, a secondary battery internal cell stack which is formed in a stacked form of a Z-folding (zigzag folding or accordion folding type) type are disclosed in several related arts.

In this case, a separation membrane 3 is folded in zigzags and is stacked in a form in which the anode plate 1 and the cathode plate 2 are alternately inserted, having the separation member disposed therebetween. In this case, the battery cell having the above form may considerably reduce the durability due to the deterioration described above. Therefore, a need exists for the battery cell capable of preventing the deterioration and increasing the charging and discharging efficiency of the battery.

### DISCLOSURE

### Technical Problem

An exemplary embodiment of the present invention is directed to providing a battery cell capable of preventing durability from reducing due to deterioration and increasing charging and discharging efficiency.

### Technical Solution

In one general aspect, there is provided a battery cell, including: a cell unit configured to include a cathode plate, an anode plate, and a separation membrane; a cathode tab configured to extend from the cathode plate; an anode tab configured to extend from the anode plate; and a case configured to have the cathode tab and the anode tab protruding to an outside and have the cell unit disposed therein to be sealed, wherein one or both of the cathode tab and the anode tab are formed in at least two.

The cathode tab and the anode tab may protrude from at least two sides selected from up, down, left, and right directions of the case.

The cathode tab and the anode tab may be formed in parallel in two on sides selected from up, down, left, and right directions of the case.

Charging and discharging may be performed by different cathode tabs and anode tabs.

The separation membrane may be folded in zigzags and the cathode plate and the anode plate may be stacked by being alternately inserted, having the separation member disposed therebetween.

### Advantageous Effects

As set forth above, according to the embodiments of the present invention, the battery cell may prevent the durability from reducing due to the deterioration and increase the charging and discharging efficiency.

### BRIEF DESCRIPTION OF THE DRAWINGS

FIGS. 1 and 2 are a perspective view and an exploded perspective view illustrating a battery cell according to an embodiment of the present invention.

FIG. 3 is a front view illustrating the battery cell according to the embodiment of the present invention.

FIGS. 4 and 5 are a perspective view and an exploded perspective view illustrating a battery cell according to another embodiment of the present invention.

FIG. 6 is an exploded perspective view illustrating the battery cell according to another embodiment of the present invention.

FIGS. 7 and 8 are a perspective view and a cross-sectional view illustrating a cell unit of the battery cell according to the embodiment of the present invention.

### DETAILED DESCRIPTION OF MAIN ELEMENTS

| 100: Battery cell | |
|---|---|
| 110: Case | |
| 120: Cell unit | 121: Cathode plate |
| 122: Anode plate | 123: Separation plate |

130: Cathode tab (when two cathode tabs are formed,
131: First cathode tab, 132: Second cathode tab)
140: Anode tab (when two anode tabs are formed, 141:
First anode tab, 142: Second anode tab)

### BEST MODE

Hereinafter, a battery cell 100 according to an embodiment of the present invention having features as described above will be described with reference to the accompanying drawings.

The battery cell 100 according to the embodiment of the present invention is configured to include a cell unit 120, a cathode tab 130, an anode tab 140, and a case 110, in which one or both of the cathode tab 130 and the anode tab 140 are formed in at least two.

A cell unit 120 is configured to include a cathode plate 121, an anode plate 122, and a separation membrane and is provided inside the case 110.

The separation membrane is disposed between the cathode plate 121 and the anode plate 122 and the cathode plate 121, the separation membrane, the anode plate 122 are disposed inside the case 110 together with an electrolyte.

The cathode tab 130 and the anode tab 140 are configured to extend from the cathode plate 121 and the anode plate 122 to charge and discharge the cell unit 120 and protrude to an outside of the case 110.

In this case, the cathode tab 130 and the anode tab 140 may be welded to the cathode plate 121 and the anode plate 122.

The case 110 is a basic body forming the battery cell 100 and is sealed in a pouched type.

In this case, as the case 110, a member of a film type may be used or a member having a space in which the battery cell 120 may be formed may be used.

The battery cell 100 according to the embodiment of the present invention may have the cathode tab 130 and the anode tab 140, in which one or both of the cathode tab 130 and the anode tab 140 may be at least two.

That is, in the battery cell 100 according to the embodiment of the present invention, the cathode tab 130 and the anode tab 140 which are formed on one of the cathode plate 121 and the anode plate 122 may be at least two and the cathode tab 130 and the anode tab 140 which are formed on both of the cathode plate 121 and the anode plate 122 may be at least two.

In this case, at least two cathode tabs 130 or anode tabs 140 may be performed by a combination that charging and discharging are different.

The cathode tab 130 and the anode tab 140 may protrude from at least two sides selected from up, down, left, and right directions of the case 110 and the two cathode tabs 130 and anode tabs 140 may be formed in parallel on at sides selected from up, down, left, and right directions of the case 110.

Therefore, in the battery cell 100 according to the embodiment of the present invention, one or both of the cathode tab 130 formed on the cathode plate 121 and the anode tab 140 formed on the anode plate 122 are formed in at least two, thereby separating charging and discharging tabs from each other, preventing durability from reducing due to deterioration, and increasing charging and discharging efficiency.

Hereinafter, various formation examples of the cathode tab 130 and the anode tab 140 will be described based on first to fourth embodiments illustrated in the drawings.

### First Embodiment

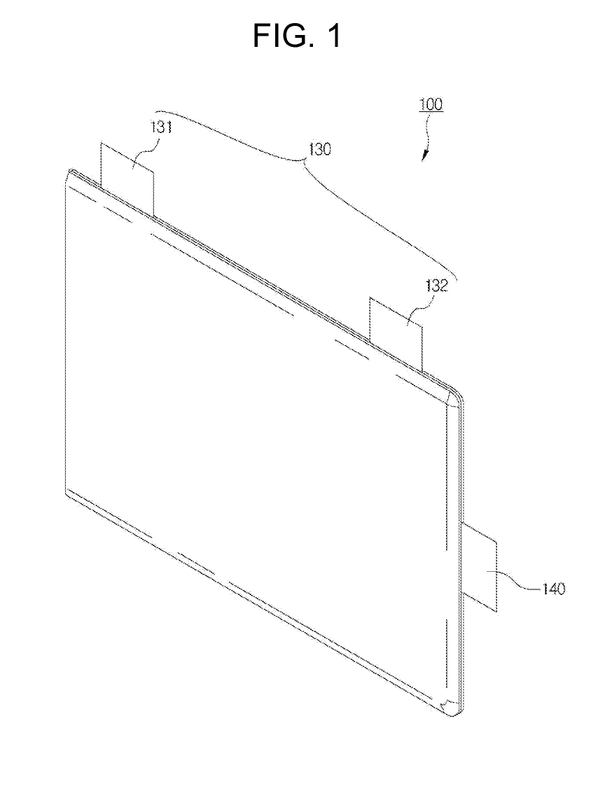

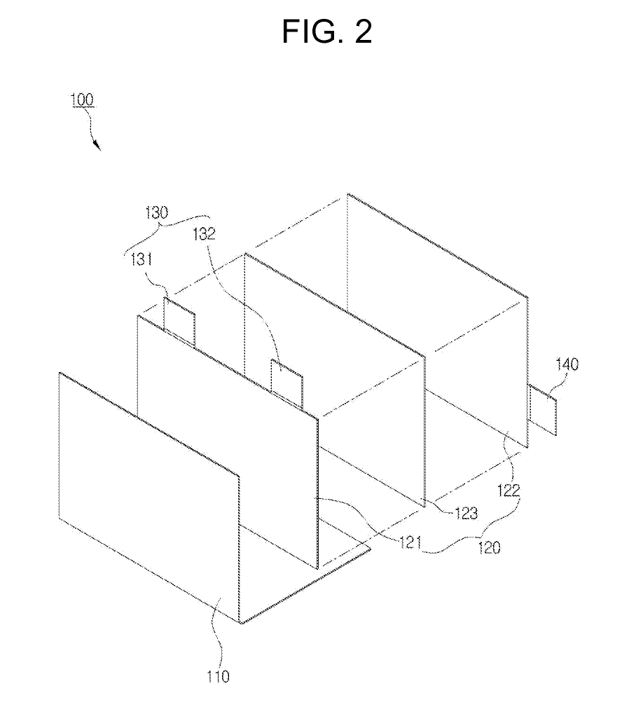

In the battery cell 100 according to a first embodiment of the present invention illustrated in FIGS. 1 and 2, the case 110 is folded based on a lower surface to be sealed each other. In this case, there is illustrated an example in which the cathode tab 130 includes a first cathode tab 131 and a second cathode tab 132 which are disposed on an upper surface of the case 110 to be spaced apart from each other at a predetermined distance and one anode tab 140 is disposed on a right surface of the case 110.

### Second Embodiment

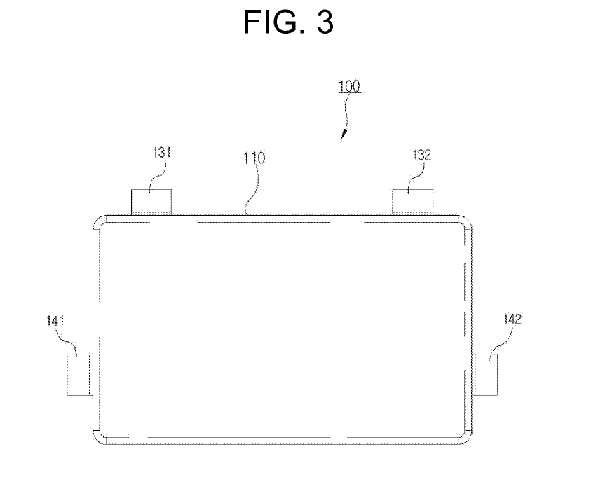

The battery cell 100 according to the second embodiment of the present invention illustrated in FIG. 3 is the same as the form illustrated in FIGS. 1 and 2, but there is illustrated an example in which the anode tab 140 includes a first anode tab 141 and a second anode tab 142 which are each disposed on left and right surfaces of the anode plate 122.

In this case, the first cathode tab 131 and the second anode tab 142 may be formed to perform a charging function and the second cathode tab 132 and the first anode tab 141 may be formed to perform a discharging function, or vice versa.

### Third Embodiment

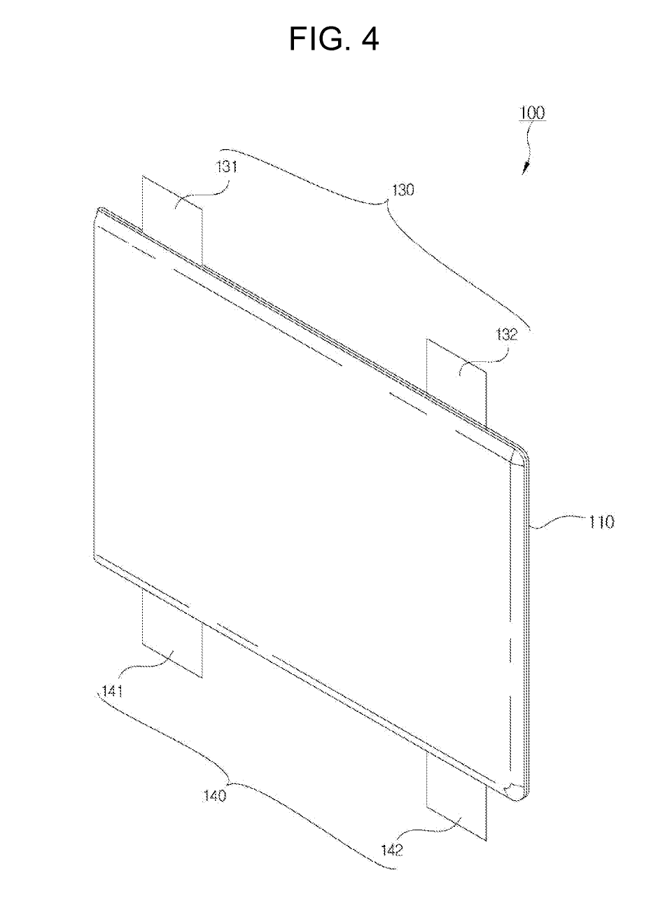

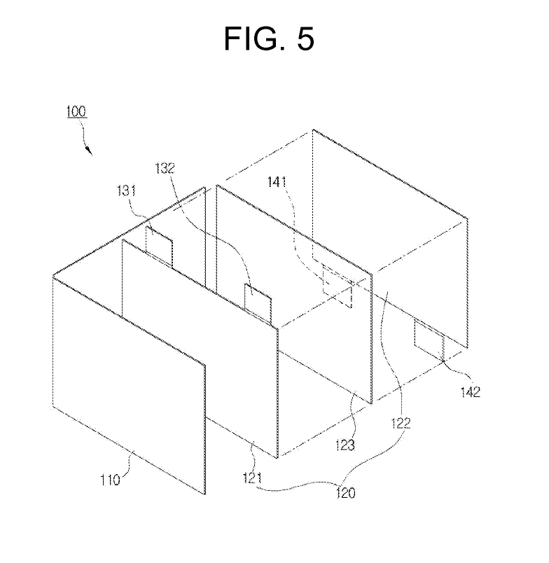

In the battery cell 100 according to a third embodiment of the present invention illustrated in FIGS. 4 and 5, the case 110 is folded based on the left surface to be sealed each other. In this case, there is illustrated an example in which the cathode tab 130 includes the first cathode tab 131 and the second cathode tab 132 which are disposed on the upper surface of the case 110 to be spaced apart from each other at a predetermined distance and the anode tab 140 includes the first anode tab 141 and the second anode tab 142 which are disposed on the lower surface of the case 110 to be spaced apart from each other at a predetermined distance.

### Fourth Embodiment

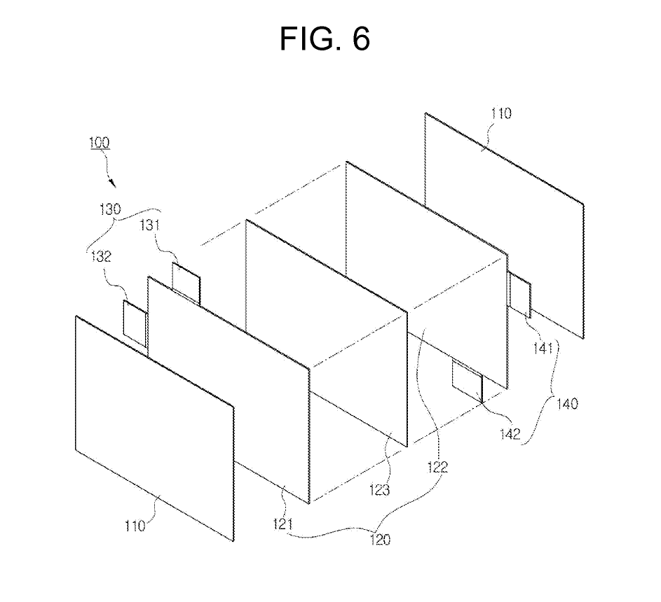

In the battery cell 100 according to a fourth embodiment of the present invention illustrated in FIG. 6, the case 110 is formed being divided into two configurations. In this case, there is illustrated an example in which the cathode tab 130 includes the first cathode tab 131 and the second cathode tab 132 which are disposed on one portion of the upper surface and one portion of the side of the case 110 and the anode tab 140 includes the first anode tab 141 and the second anode tab 142 which are disposed on the other portion of the lower surface and the other portion of the side of the case 110.

Further, although not illustrated in the drawings, in the battery cell 100 according to the embodiment of the present invention, the cathode plate 121 includes the first cathode tab 131 and the second cathode tab 132 which are disposed on the upper and lower portions of the case 110 and both sides of the anode plate 122 may be provided with the first anode tab 141 and the second anode tab 142.

### Fifth Embodiment

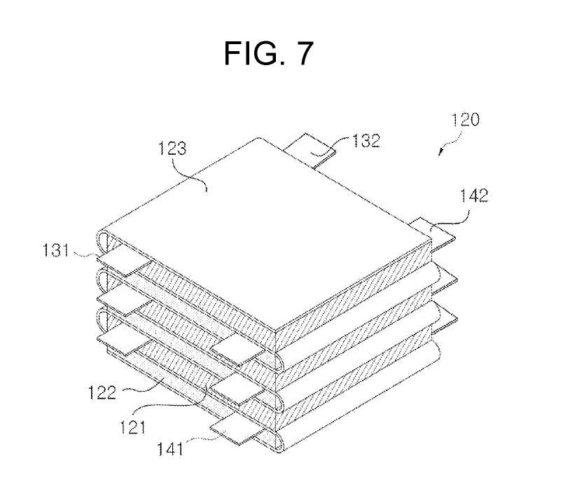

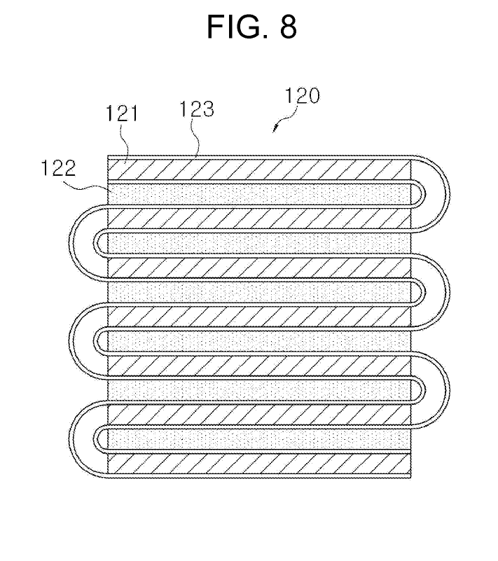

In the battery cell 100 according to the fifth embodiment of the present invention illustrated in FIGS. 7 and 8, the separation membranes are folded in zigzags and there is illustrated an example in which the separation membranes are stacked in a form in which the anode plate 1 and the cathode plate 2 are alternately inserted, having the separation member disposed therebetween, and FIG. 7 illustrates an example in which the cathode tab 130 is configured to include the first cathode tab 131 and the second cathode tab 132 which protrude in front and back directions and the anode tab 140 is configured to include the first anode tab 141 and the second anode tab 142 protruding in front and back directions.

However, the first to fourth embodiments are one embodiment of the battery cell and in the battery cell according to the embodiment of the present invention, the cathode tab and the anode tab may be formed on the contrary to the cathode tab and the anode tab formed in the first to fourth embodiments and in addition to the above example, the number and formation positions of cathode tabs and anode tabs may be more variously changed.

The present invention is not limited to the above-mentioned exemplary embodiments but may be variously applied, and may be variously modified by those skilled in the art to which the present invention pertains without departing from the gist of the present invention claimed in the claims.

1. A battery cell, comprising:
a cell unit configured to include a cathode plate, an anode plate, and a separation membrane;
a cathode tab configured to extend from the cathode plate;
an anode tab configured to extend from the anode plate; and
a case configured to have the cathode tab and the anode tab protruding to an outside and have the cell unit disposed therein to be sealed,
wherein one or both of the cathode tab and the anode tab are formed in at least two.

2. The battery cell of claim 1, wherein the cathode tab and the anode tab protrude from at least two sides selected from up, down, left, and right directions of the case.

3. The battery cell of claim 2, wherein the cathode tab and the anode tab are formed in parallel in two on sides selected from up, down, left, and right directions of the case.

4. The battery cell of claim 2, wherein charging and discharging are performed by different cathode tabs and anode tabs.

5. The battery cell of claim 4, wherein the separation membrane is folded in zigzags, and
the cathode plate and the anode plate are stacked by being alternately inserted, having the separation member disposed therebetween.
